(19) United States
(12) Patent Application Publication
(10) Pub. No.: US 2011/0289407 A1
(43) Pub. Date: Nov. 24, 2011

(54) FONT RECOMMENDATION ENGINE

(76) Inventors: Devang K. Naik, San Jose, CA (US); Peter G. Lofting, San Jose, CA (US)

(21) Appl. No.: 12/782,646

(22) Filed: May 18, 2010

(51) Int. Cl. G06F 17/00; G06F 9/46

(52) U.S. Cl. 715/269; 719/328

(57) ABSTRACT

At least certain embodiments of the present disclosure include a method to identify top hits in search result based on learned user preferences. In one embodiment, an editor receives a user selection of a font to be used in a document when the user is composing the document using the editor. The editor invokes a font recommendation engine. Based on the font selected, the font recommendation engine automatically recommends a set of one or more fonts to the user according to a statistical model of font usage.

### FIELD OF THE DISCLOSURE

This disclosure relates to document preparation and particularly to selection of one or more fonts.

### BACKGROUND OF THE DISCLOSURE

Conventionally, editors, such as work processing software executable on personal computers, provide a large number of fonts. However, users of the editors typically use only a few of the fonts available in composing documents because users are unfamiliar with the vast number of fonts supported by the system as well as those available for purchase. Currently, many editors provide an arbitrarily ordered list of names of fonts available and a limited preview of each via a graphical user interface, such as a drop-down menu, a pop-up window, etc. It is generally very difficult for users to choose and compare fonts out of the list because of the limited information provided. Moreover, conventional editors typically do not provide any further information on fonts, other than the list of font names, to help users in choosing fonts when composing documents.

### SUMMARY OF THE DESCRIPTION

Some embodiments include one or more application programming interfaces (APIs) in an environment with calling program code interacting with other program code being called through the one or more interfaces. Various function calls, messages or other types of invocations, which further may include various kinds of parameters, can be transferred via the APIs between the calling program and the code being called. In addition, an API may provide the calling program code the ability to use data types or classes defined in the API and implemented in the called program code.

At least certain embodiments include an environment with a calling software component interacting with a called software component through an API. A method for operating through an API in this environment includes transferring one or more function calls, messages, other types of invocations or parameters via the API.

Some embodiments of the present disclosure include a method for generating a statistical model of font usage. In one embodiment, a font usage modeling device analyzes font usage in a set of training documents. Then the likelihoods or probabilities of co-occurrences of fonts in the training documents are computed. Using the likelihoods of co-occurrences, a statistical model of font usage is generated. The statistical model of font usage may be used in real-time font recommendation.

Some embodiments of the present disclosure include a method for recommending fonts based on a user selected font or a user selected type of document. In one embodiment, an editor receives a user selection of at least one of: (1) a font to be used in a document when the user is composing the document using the editor, or (2) a type of document (e.g., a user selects a template for a document from a list of a plurality of templates, where each template is a type of document). Based on the font selected or the type of document selected, a font recommendation engine automatically recommends a set of one or more fonts to the user according to a statistical model of font usage. In some embodiments, a frequency of the user selected font co-existing with the set of one or more fonts in a set of training documents used to generate the statistical model is above a predetermined threshold.

According to one further aspect of the invention, the editor detects a font selected by a user, and the editor may automatically obtain font recommendations based on the user selected font in real-time. The editor may display the font recommendations to the user. The user is allowed to select a font from the fonts recommended to use with the font previously selected in the document. In addition to fonts, the font recommendation engine may make other font-related recommendations, such as font size, font color, spacing, etc. In some embodiments, a font recommended may be offered for sale to the user if the font recommended is not available in the editor.

Various devices which perform one or more of the foregoing methods and machine-readable media which, when executed by a processing system, cause the processing system to perform these methods, are also described.

Other methods, devices and machine-readable media are also described.

### BRIEF DESCRIPTION OF THE DRAWINGS

The disclosure is described by way of example with reference to the accompanying drawings, wherein:

FIG. 1 illustrates a block diagram of an exemplary API architecture usable in some embodiments of the invention;

FIG. 2 is an exemplary embodiment of a software stack usable in some embodiments of the invention;

FIG. 3 illustrates one embodiment of a font usage modeling device;

FIG. 4 illustrates a flow chart of one embodiment of a method to generate a statistical model of font usage usable in font recommendation;

FIG. 5 illustrates one embodiment of a font recommendation engine; and

FIG. 6 is a flow chart of one embodiment of a method to recommend fonts to a user;

FIG. 7 is a flow chart of one embodiment of a method to recommend fonts to a user; and

FIG. 8 shows one embodiment of a device usable in some embodiments of the present disclosure.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a through understanding of various embodiments of the present disclosure. However, in certain instances, well-known or conventional details are not described in order to provide a concise discussion of embodiments of the present disclosure.

Some portions of the detailed descriptions, which follow, are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing or transmitting information in a form readable by a machine (e.g., a computer). For example, machines store and communicate (internally and with other devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.).

At least certain embodiments of the present disclosure include one or application programming interfaces in an environment with search software interacting with a software application. Various function calls or messages are transferred via the application programming interfaces between the search software and software applications. Transferring the function calls or messages may include issuing, initiating, invoking or receiving the function calls or messages. Example application programming interfaces transfer function calls to implement various operations (e.g., search, networking, service discovery, etc.) for a device having a display region. An API may also implement functions having parameters, variables, or pointers. An API may receive parameters as disclosed or other combinations of parameters. In addition to the APIs disclosed, other APIs individually or in combination can perform similar functionality as the disclosed APIs.

The display region may be in a form of a window. A window is a display region which may or may not have a border and may be the entire display region or area of a display. In some embodiments, a display region may have at least one window and/or at least one view (e.g., web, text, or image content). The methods, systems, and apparatuses disclosed can be implemented with display regions, windows, and/or views.

In some embodiments, a platform provides various editing and networking operations. The platform includes hardware components and an operating system. The hardware components may include a processing unit coupled to an input panel and a memory coupled to the processor. The operating system includes one or more programs that are stored in the memory and configured to be executed by the processing unit. One or more programs include various instructions for transferring function calls or messages through an Application Programming Interface (API) in order to perform various editing and networking operations.

One or more APIs may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and pass data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however, the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

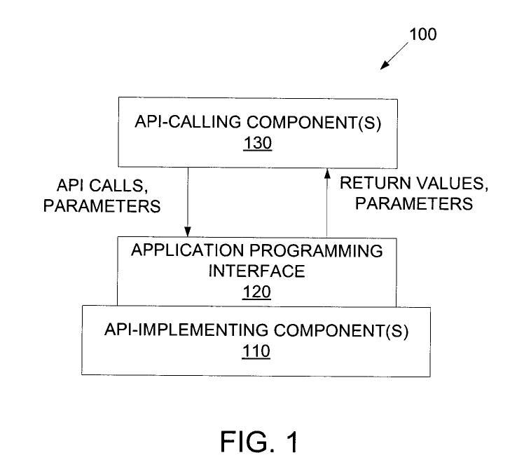

FIG. 1 is a block diagram illustrating an exemplary API architecture, which may be used in some embodiments of the invention. As shown in FIG. 1, the API architecture 100 includes the API-implementing component 110 (e.g., an operating system, a library, a device driver, an API, an application program, software or other module) that implements the API 120. The API 120 specifies one or more functions, methods, classes, objects, protocols, data structures, formats and/or other features of the API-implementing component that may be used by the API-calling component 130. The API 120 can specify at least one calling convention that specifies how a function in the API-implementing component receives parameters from the API-calling component and how the function returns a result to the API-calling component. The API-calling component 130 (e.g., an operating system, a library, a device driver, an API, an application program, software or other module) makes API calls through the API 120 to access and use the features of the API-implementing component 110 that are specified by the API 120. The API-implementing component 110 may return a value through the API 120 to the API-calling component 130 in response to an API call.

It will be appreciated that the API-implementing component 110 may include additional functions, methods, classes, data structures, and/or other features that are not specified through the API 120 and are not available to the API-calling component 130. It should be understood that the API-calling component 130 may be on the same system as the API-implementing component 110 or may be located remotely and accesses the API-implementing component 110 using the API 120 over a network. While FIG. 1 illustrates a single API-calling component 130 interacting with the API 120, it should be understood that other API-calling components, which may be written in different languages (or the same language) than the API-calling component 130, may use the API 120.

The API-implementing component 110, the API 120, and the API-calling component 130 may be stored in a machine-readable medium, which includes any mechanism for storing information in a form readable by a machine (e.g., a computer or other data processing system). For example, a machine-readable medium includes magnetic disks, optical disks, random access memory; read only memory, flash memory devices, etc.

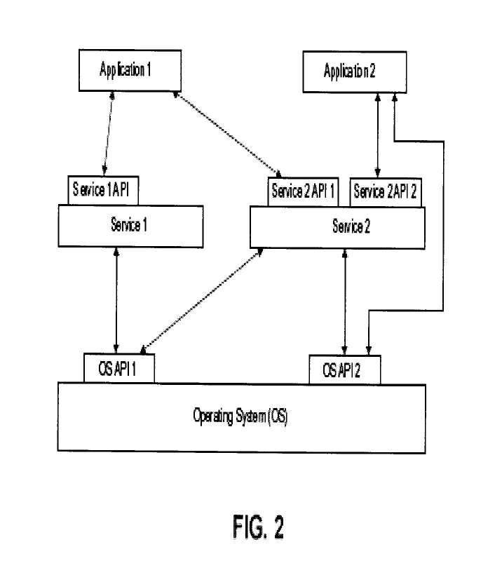

In FIG. 2 (“Software Stack”), an exemplary embodiment, applications can make calls to Services 1 or 2 using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

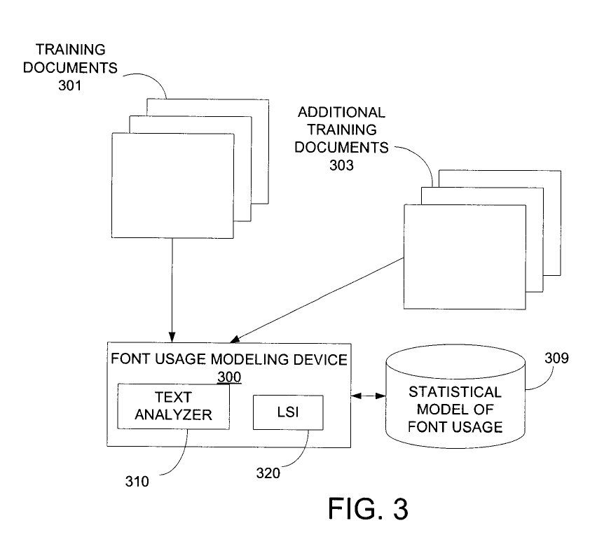

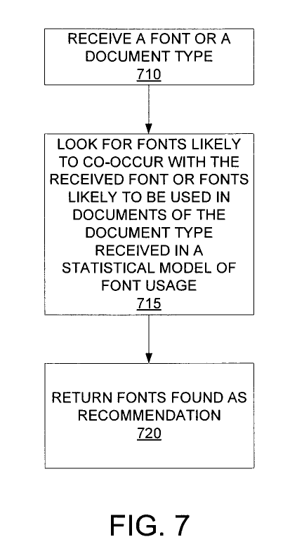

FIG. 3 illustrates one embodiment of a font usage modeling device. Font usage modeling device 300 can be implemented with a data processing device, such as the device illustrated in FIG. 7 in some embodiments. In some embodiments, font usage modeling device 300 includes a text analyzer 310 and a latent semantic indexer (LSI) 320. In general, text analyzer 310 is operable to analyze the text in a document or a predetermined section of the document (e.g., a page, a paragraph, etc.) to determine various characteristics of the text, such as the font and font size in which the text is written, the position or layout of the text, the part of the document in which the text is (e.g., title, body, footnote, etc.), etc., and LSI 320 is operable to index fonts found in documents with the documents in order to identify fonts that are likely to co-exist in the documents. To further illustrate the operations of font usage modeling device 300, some examples are discussed in details below.

In some embodiments, a set of training documents 301 is provided to font usage modeling device 300. A document broadly refers to a piece of literary work authored and designed by one or more persons, such as a newspaper article, a report published in a magazine, an invitation (e.g., birthday party invitation, wedding invitation, etc.), a newsletter, an announcement, etc. Typically, the text in a document is written in multiple fonts, which may be in different colors and sizes. Thus, each training document, or a predetermined section thereof (e.g., a page, a paragraph, etc.), can be considered as a repository of fonts. The set of training documents 301 may include templates of documents previously authored by people working for a software vendor, documents collected online, which are authored or designed by different people, etc. The set of training documents 301 typically includes a sample of documents large enough to reflect how the general public or a specific demographic of interest uses fonts. For instance, the set of training documents 301 may be selected based on culture of a geographical area in which the statistical model to be generated will be used. In one example, English documents widely circulated in the United Kingdom may be chosen to be included in the set of training documents 301 if the statistical model to be generated is going to be used mostly in the United Kingdom, whereas English documents widely circulated in the United States may be chosen to be included in the set of training documents 301 if the statistical model to be generated is going to be used mostly in the United States. This is because the cultures in the United Kingdom and the United States are different even though both countries use English. Such differences in cultures may affect popularities of various font combinations and preferences in font usage. Furthermore, the training documents 301 may be selected based on other criteria, such as genre, literary style, emotional aspect associated with different types of documents, etc.

For each training document, or each predetermined section thereof, text analyzer 310 analyzes the text in the respective training document to identify the fonts used. In some embodiments, text analyzer 310 further collects additional information about the fonts used and the training document. For example, text analyzer 310 may identify the font size, spacing, parts of the respective training document in which a font is used (e.g., title, body, footnote, etc.), content or genre of the respective training document (e.g., wedding invitation, financial report, product manual, etc.), geographic origin of the respective training document (e.g., geographic region, country, city, etc.), etc. Then text analyzer 310 outputs the information collected from training documents 301 to LSI 320.

In some embodiments, LSI 320 correlates the fonts found in training documents 301 with training documents 301. Specifically, LSI 320 may employ Singular Value Decomposition (SVD) to identify a pattern of font usage in the training documents 301. Moreover, LSI 320 may compute the probabilities of co-occurrences of multiple fonts or compute the distances between vectors that represent multiple fonts in training documents 301. Using the font usage patterns identified and the probability of font co-occurrences, font usage modeling device 300 can generate a statistical model of font usage 309.

In some embodiments, text analyzer 310 further collects font-related information in the training documents, such as font size, font color, spacing, etc. LSI 320 may correlate these font-related features with the fonts found in training documents 301 and include such correlation in statistical model of font usage 309. Statistical model of font usage 309 may be used by font recommendation engines to determine the fonts to recommend to a user in response to the user selecting a particular font when composing a document.

In some embodiments, statistical model of font usage 309 may lack coverage on a particular font because the particular font is not used, or used sparingly, in training documents 301. As such, font usage modeling device 300 may be requested to obtain or collect additional training documents 303 that use the particular font so that font usage modeling device 300 can re-generate a statistical model of font usage 309 with better coverage on the particular font based on the additional training documents 303 and the original training documents 301.

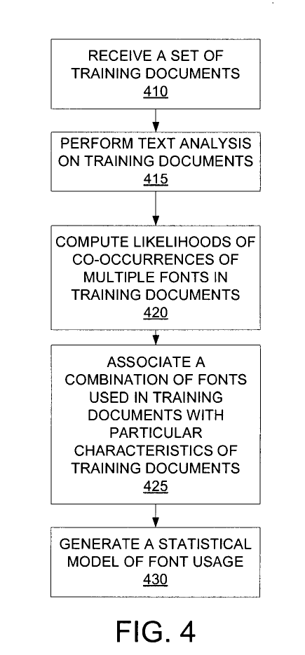

FIG. 4 illustrates a flow chart of one embodiment of a method to generate a statistical model of font usage usable in font recommendation. The method can be performed by processing logic including hardware, software, firmware, or a combination of any of the above. For example, the method can be performed by font usage modeling device 300 illustrated in FIG. 3 in some embodiments.

Initially, processing logic receives a set of training documents at box 410. In some embodiments, processing logic performs text analysis on each training document, or each predetermined section thereof (e.g., each page, each paragraph, each chapter, etc.), in box 415. Specifically, processing logic may identify the part (e.g., heading, caption, body, footnote, etc.) of a training document in which a font is being used. For instance, the font Arial of size 24 may be used in a title or heading of a training document, both the font Arial of size 12 and the font Times of size 12 may be used in the body of the training document, and the font Times of size 8 may be used in a footnote of the training document.

In some embodiments, processing logic may further classify the training documents into different categories by the contents of the training documents. For example, processing logic may classify the training documents by languages (e.g., English, German, Japanese, etc.) in which the training documents are written. In another example, training documents may be classified by their contents (e.g., wedding invitations, financial reports, news articles, recipes, etc.). In some further embodiments, processing logic may classify the training documents by other characteristics of the training documents, such as the geographic origins of the training documents (e.g., Europe, Asia Pacific, Canada, Midwest of America, East Coast of America, etc.), genre, emotional aspects associated with different types of documents, literary style, etc. Processing logic may use tags of documents to obtain the above information of the training documents.

Then processing logic computes likelihoods of co-occurrences of multiple fonts in the training documents at box 420. In other words, processing logic determines, for each font found in the training documents, how likely is the font being used with one or more other fonts in the same training document or in the same section (e.g., the same page, the same paragraph, etc.) of a training document. The more likely the font co-occurs with a second font in the training documents, the more popular the combination of the font and the second font is. In fact, if the combination of the font and the second font enjoys great popularity, then it may indicate that the font and the second font go well together. Thus, it would be a good idea to recommend the fonts that are likely to co-occur with each other in the training documents to users who have selected one of the fonts to use. Various techniques may be employed to determine the likelihoods of font co-occurrences in different embodiments.

In one embodiment, LSI is employed. Fonts occurring in the training document are associated with distinct rows of a matrix, where each training document is associated with a distinct column of the matrix. The number of occurrences of a font in a particular training document is entered into the matrix on the corresponding row and in the corresponding column. The matrix may be normalized to allow comparison of training documents of various sizes. Then processing logic may apply SVD to map the matrix to a smaller space, referred to as a similarity space. Then sets of fonts close to each other in the similarity space can be identified.

In an alternate embodiment, N-grams can be used to determine the likelihood of occurrences of fonts in the training documents. In general, an N-gram includes N elements, where N is an integer (e.g., 1, 2, 3, etc.). Each element in an N-gram represents a font. In other words, an N-gram represents a combination of N fonts. Then the frequency of occurrences of an N-gram in the set of training documents is determined. In one example, for each N-gram occurring in a training document, processing logic increments a corresponding count or entry in a font occurrence table. As such, processing logic tallies up the occurrences of each N-gram in the training documents. For each N-gram, processing logic may compute a probability of a respective N-gram occurring in the training documents using the frequency.

Alternatively, the concept of N-grams can be combined with LSI. Instead of associating distinct fonts with distinct rows in a matrix, N-grams representing combinations of fonts can be associated with distinct rows of the matrix. Furthermore, the N-grams may include N-grams of various sizes, such as bi-grams, tri-grams, etc.

At box 425, the probabilities of co-occurrences of fonts in the training documents may be associated with certain characteristics of the training documents using the information collected about the fonts and the training documents in box 415. In other words, a font or a combination of fonts may be correlated with other characteristics of the training documents. Such correlation may be useful for providing more tailored font recommendation to users later. For example, based on the co-occurrences of fonts in different parts of the training documents, processing logic may compute probabilities of co-occurrences of fonts with respect to different parts of the training documents. In another example, processing logic may compute probabilities of co-occurrences of fonts with respect to different languages used in the training documents. In some embodiments, processing logic associates a combination of fonts used in the training documents with a particular type of contents or a particular genre. Because certain combination of fonts may be used more frequently for a certain type of contents or genre, processing logic may associate the likelihood of co-occurrences of a combination of fonts with a particular type of contents or a particular genre.

Finally, at box 430, processing logic generates a statistical model of font usage using the likelihoods of co-occurrences of fonts and the information of the training documents determined above. In some embodiments, processing logic may periodically update the statistical model. For example, processing logic may periodically search online for new documents, some of which contain new fonts, and add the new documents found into the set of training documents to expand the set. Then processing logic may repeat operations in boxes 415-430 to generate an updated statistical model of font usage. As such, the updated statistical model tracks new trends in font usage and incorporates new fonts as well.

The statistical model can be used by a font recommendation engine to determine what font(s) to recommend when a user selects a font while composing or editing a document. For example, the statistical model may be downloaded by font recommendation engines running on client devices, on which users edit documents. Some embodiments of a font recommendation engine are discussed below in details.

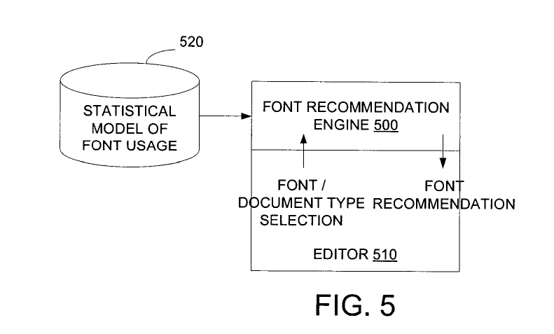

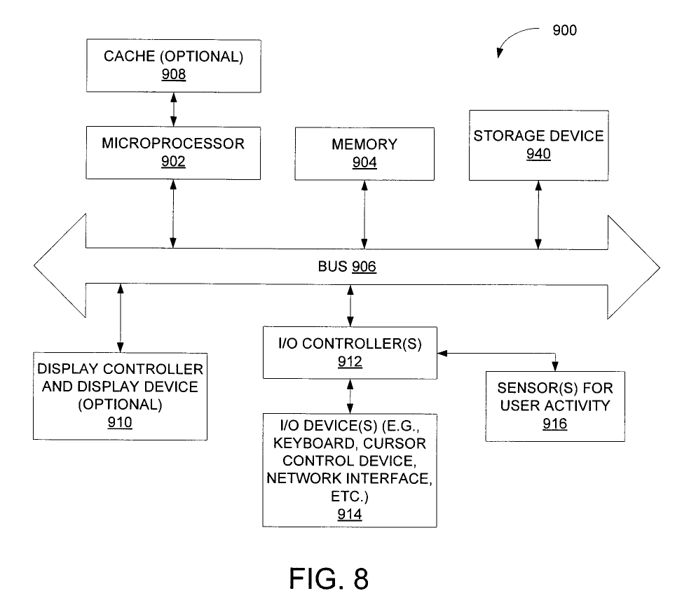

FIG. 5 illustrates one embodiment of a font recommendation engine. Font recommendation engine 500 may be implemented with software executable on a data processing device, such as the device illustrated in FIG. 8 in some embodiments. In the current example illustrated in FIG. 5, font recommendation engine 500 is a separate module usable by an editor 510. Alternatively, font recommendation engine 500 may be integrated with an editor. In general, editor 510 is executable on a data processing system (e.g., a personal computer, a personal digital assistant, etc.) to allow a user to edit or compose a document. Editor 510 typically provides a graphical user interface (GUI) to receive user inputs (e.g., text, font selection, layout selection, etc.), and to display a document being edited.

In some embodiments, editor 510 receives, via the GUI, a user selection of a particular font to use in the document. In response, editor 510 sends the user selected font to font recommendation engine 500. Font recommendation engine 500 retrieves a statistical model of font usage 520 and inputs the user selected font to the statistical model 520 to find one or more fonts that are likely to co-occur with the user selected font. Then font recommendation engine 500 returns the one or more fonts found to editor 510, which presents the one or more fonts found, via the GUI, to the user to recommend them to the user. Thus, font recommendation engine 500 can provide recommendation of fonts to the user in real-time. In some embodiments, font recommendation engine 500 further orders the fonts recommended according to the popularity of the combinations of the fonts recommended and the user selected font such that editor 510 can display the font recommendations in the order of their popularities. In some embodiments, editor 510 may display the fonts recommended based on user preferences. For example, some of the fonts recommended may not yet be available in editor 510 (which may be purchased from a font vendor). The user may request editor 510 to display fonts that are available first, then followed by fonts not yet available in editor 510. Alternatively, the user may request editor 510 to display only fonts that are available in editor 510.

In some alternate embodiments, editor 510 receives, via the GUI, a user selection of a particular type of document, such as by selection of a template out of a set of predefined templates, each of which being associated with a particular type of documents. In response, editor 510 sends the user selected document type to font recommendation engine 500. Font recommendation engine 500 retrieves a statistical model of font usage 520 and inputs the user selected document type to the statistical model 520 to find one or more fonts that are likely to occur in the user selected type of documents. Font recommendation engine 500 returns the font(s) found to editor 510, which may display the font(s) found via a GUI in order to recommend the font(s) found to the user.

In some embodiments, statistical model of font usage 520 is stored locally in the data processing device. Statistical model of font usage 520 can be updated periodically to model the latest trend in font usage and/or to include new fonts created since the statistical model 520 was last generated. The data processing device may periodically download the updated statistical model 520 from font usage modeling device 300 illustrated in FIG. 3.

In some embodiments, editor 510 may provide additional information to font recommendation engine 500 to be used in determining which fonts to recommend to the user. For example, editor 510 may provide the location of the document at which the user selected font is used, the type of contents of the document, the genre of the document, the layout of the document, the literary style of the document, the emotional aspect associated with the document, the language in which the document is being written, etc. This additional information may be used to fine-tune the font recommendation. For example, the user selected font is commonly used with fonts A and B in financial reports and wedding invitations, respectively. Therefore, if the document being composed is a wedding invitation, font recommendation engine 500 would recommend font B, not font A, to the user. In another example, the user selected font is commonly used with font X and Y in English documents and German documents, respectively. Therefore, if the document being composed is in English, then font recommendation engine 500 would recommend font X, not font Y.

In some embodiments, font recommendation engine 500 may determine if other font-related recommendations can be made, such as font sizes, font colors, spacing between lines of text, etc., based on statistical model of font usage 520. In addition to fonts that are likely to co-occur with a particular font, statistical model of font usage 520 may further identify other font-related features, such as font size, font color, spacing, etc., that may co-occur with the particular font. As such, font recommendation engine 500 can recommend fonts with the appropriate font-related features as well.

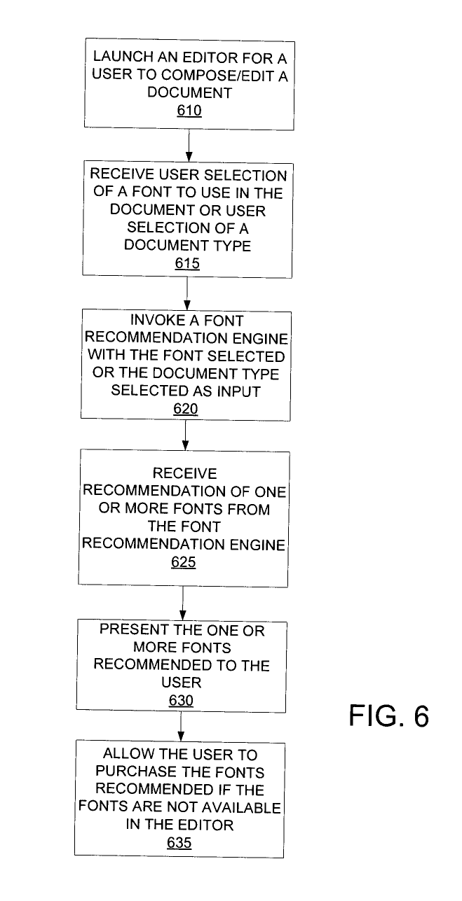

FIG. 6 is a flow chart of one embodiment of a method to recommend fonts to a user. The method can be performed by a computing device having processing logic that includes hardware, software, firmware, or a combination of any of the above. For example, the method can be performed by the device illustrated in FIG. 8 in some embodiments.

In some embodiments, processing logic launches an editor for a user to compose or edit a document at block 610. The editor may provide a GUI to receive inputs from the user and to display the document being edited to the user. At block 615, processing logic receives user selection of a font to use in the document, or user selection of a document type. For example, the user may have selected a font from a drop-down menu displaying a list of fonts available in the editor. In another example, the user may have selected a document type by selecting a template out of a group of predefined templates from a drop-down menu.

In response to the user selection of the font or the document type, processing logic invokes a font recommendation engine and inputs the user selected font or document type to the font recommendation engine at block 620. In some embodiments, processing logic may input additional information on the document to the font recommendation engine, such as genre of the document, literary style of the document, language used in the document, location of the selected font being used in the document, layout of the document, etc. The font recommendation engine is operable to recommend one or more fonts based on a statistical model of font usage, the user selected font or document type, and optionally, the additional information on the document. Some embodiments of how to generate a statistical model of font usage have been discussed above. At block 625, processing logic receives recommendation of one or more fonts to use with the font selected from the font recommendation engine. Then processing logic presents the one or more fonts recommended to the user via the GUI at block 630. For example, processing logic may generate a pop-up window displaying combinations of one or more fonts recommended, ordered by the popularity of the combinations according to the statistical model of font usage. Processing logic may further allow the user to choose from the fonts recommended to compose the document.

In some embodiments, processing logic allows the user to purchase a font recommended if the font is not available in the editor at block 635. For example, processing logic may indicate to the user, along with the font recommendation, that the font is not available in the editor currently, but offer to sell the font to the user. Processing logic may further connect the processing device to a server of a font vendor that offers the font to allow the user to purchase the font from the font vendor.

FIG. 7 is a flow chart of one embodiment of a method to recommend fonts to a user. The method can be performed by a computing device having processing logic that includes hardware, software, firmware, or a combination of any of the above. For example, the method can be performed by font recommendation engine 500 illustrated in FIG. 5 in some embodiments.

In some embodiments, processing logic receives a font or a document type as an input at block 710. The font is selected by a user while working on a document. Then processing logic accesses a statistical model of font usage to look for fonts likely to co-occur with the font received or fonts likely to be used in documents of the document type received according to the statistical model at block 715. For example, processing logic may simply look for fonts having a probability of co-occurrence with the font received above a predetermined threshold. Alternatively, processing logic may look for fonts close to the font received in a similarity space within the statistical model. Groups or combinations of fonts may be found close to the font received in the similarity space. Each group includes one or more fonts likely to co-occur with the font received according to the statistical model. The more likely a group of fonts are to co-occur with the font received, the more popular the combination of the group of fonts and the font received is. Because a high popularity of a combination of fonts generally indicate that the fonts go well together, it makes sense to recommend fonts that are likely to co-occur with the font received.

In some embodiments, processing logic receives additional information, if available, on the document which the user is working on, such as genre of the document, literary style of the document, language used in the document, location of the font to be used in the document, layout of the document, etc. The additional information may be used to fine-tune the font recommendation. Specifically, the probability of co-occurrences of fonts may be associated with certain characteristics of documents in the statistical model of font usage. For instance, the probabilities of co-occurrences of two fonts, A and B, with respect to documents in different genre may be different. In one example, fonts A and B may be frequently used in wedding invitations, but rarely in financial reports. Therefore, processing logic may recommend font B if font A is input and the document that the user is working on is a wedding invitation. But processing logic may not recommend font B if font A is input, but the document that the user is working on is a financial report.

Finally, processing logic returns the fonts that are likely to co-occur with the font received or the fonts that are likely to be used in documents of the document type received as the recommended fonts at block 720. In some embodiments, processing logic further makes other font related recommendations, such as font size, font color, spacing between lines of text, etc., if the statistical model provides likelihood of co-occurrences and correlations of such details.

FIG. 8 shows another example of a device according to an embodiment of the disclosure. This device 900 may include a processor, such as microprocessor 902, and a memory 904, which are coupled to each other through a bus 906. The device 900 may optionally include a cache 908, which is coupled to the microprocessor 902. The device may optionally include a storage device 940 which may be, for example, any type of solid-state or magnetic memory device. Storage device 940 may be or include a machine-readable medium.

This device may also optionally include a display controller and display device 910, which is coupled to the other components through the bus 906. One or more input/output controllers 912 are also coupled to the bus 906 to provide an interface for input/output devices 914 and to provide an interface for one or more sensors 916 which are for sensing user activity. The bus 906 may include one or more buses connected to each other through various bridges, controllers, and/or adapters as are well known in the art. The input/output devices 914 may include a keypad or keyboard or a cursor control device such as a touch input panel. Furthermore, the input/output devices 914 may include a network interface, which is either for a wired network or a wireless network (e.g. an RF transceiver). The sensors 916 may be any one of the sensors described herein including, for example, a proximity sensor or an ambient light sensor. In at least certain implementations of the device 900, the microprocessor 902 may receive data from one or more sensors 916 and may perform the analysis of that data in the manner described herein.

In certain embodiments of the present disclosure, the device 900 can be used to implement at least some of the methods discussed in the present disclosure.

In the foregoing specification, the disclosure has been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A machine-readable storage medium that provides instructions that, if executed by a processor, will cause the processor to generate an application programming interface (API) that allows an API-implementing component to perform operations, the operations comprising:
receiving a user selection of at least one of: (1) a font to be used in a document when the user is composing the document or (2) a type of document; and
automatically recommending a set of one or more fonts to the user based on the font selected or the type of document selected according to a statistical model of font usage.

2. The machine-readable storage medium of claim 1, wherein the operations further comprise:
recommending a font size for each of the set of one or more fonts according to the statistical model of font usage.

3. The machine-readable storage medium of claim 1, wherein the operations further comprise:
recommending a font color for each of the set of one or more fonts according to the statistical model of font usage.

4. The machine-readable storage medium of claim 1, wherein the operations further comprise:
recommending spacing between lines of text according to the statistical model of font usage.

5. A computer-implemented method, comprising:
analyzing font usage in a plurality of training documents;
computing likelihoods of co-occurrences of multiple fonts in the plurality of training documents; and
generating a statistical model of font usage using the likelihoods of co-occurrences, the statistical model being usable in real-time font recommendation.

6. The method of claim 5, wherein computing likelihoods of co-occurrences of multiple fonts in the plurality of training documents comprises:
applying latent semantic indexing to the plurality of training documents.

7. The method of claim 5, further comprising:
performing text analysis on the plurality of training documents; and
associating a particular combination of fonts used in the plurality of training documents with a particular type of content.

8. The method of claim 5, wherein computing likelihoods of co-occurrences of multiple fonts in the plurality of training documents comprises:
selecting a plurality of N-grams, each of said plurality of N-grams representing a combination of N fonts used in at least one of the plurality of training documents, where N is an integer; and
generating the statistical model of font usage based on frequencies of occurrence of the plurality of N-grams in the plurality of training documents.

9. The method of claim 5, further comprising:
periodically updating the statistical model of font usage to track font usage trends.

10. The method of claim 5, further comprising:
searching online periodically for documents containing new fonts not available in the plurality of training documents;
expanding the plurality of training documents by adding the documents containing the new fonts into the plurality of training documents; and
periodically updating the statistical model of font usage to incorporate the new fonts.

11. The method of claim 5, further comprising:
selecting the plurality of training documents based on culture of a geographical area in which the statistical model is used, wherein the statistical model generated is specific to the culture.

12. An apparatus comprising:
an input device to receive a user selected font while a user is editing a document; and
a font recommendation engine to recommend a set of one or more fonts to the user based on the user selected font, wherein a frequency of the user selected font co-existing with the set of one or more fonts in a plurality of training documents is above a predetermined threshold.

13. The apparatus of claim 12, wherein the font recommendation engine is operable to offer a font of the set of one or more fonts for sale to the user if the user has not yet purchased the font.

14. The apparatus of claim 13, further comprising:
a network interface to communicably couple to a network to access a remote server over the network for purchasing the font from the remote server.

15. The apparatus of claim 12, further comprising:
a display device to display the set of one or more fonts; and
a second input device to allow the user to select at least one of the set of one or more fonts displayed to use in the document.

16. A machine-readable storage medium storing executable program instructions which when executed by a data processing system cause the data processing system to perform a method comprising:
detecting a first font used in composing a document;
automatically displaying a set of one or more fonts statistically likely to co-occur with the font used in a plurality of training documents; and
allowing a user to select a second font from the set of one or more fonts to use with the first font in the document.

17. The machine-readable storage medium of claim 16, wherein the method further comprises:
determining a genre of the document; and
selecting the set of one or more fonts to display based on the genre of the document.

18. The machine-readable storage medium of claim 16, wherein the method further comprises:
determining a language in which the document is composed; and
selecting the set of one or more fonts to display based on the language.

19. The machine-readable storage medium of claim 16, wherein the method further comprises:
detecting a location within the document at which the font is used; and
selecting the set of one or more fonts to display based on the location.

20. The machine-readable storage medium of claim 16, wherein automatically displaying a set of one or more fonts statistically likely to co-occur with the font used in a plurality of training documents comprises:
displaying the set of one or more fonts in an order based on popularities of the set of one or more fonts.

21. The machine-readable storage medium of claim 16, wherein automatically displaying a set of one or more fonts statistically likely to co-occur with the font used in a plurality of training documents comprises:
displaying the set of one or more fonts in an order based on user preference.

22. A computer-implemented method, comprising:
receiving a font selected by a user while composing a document;
automatically recommending a set of one or more fonts to be used in the document based on popularity of combinations of the user selected font and the set of one or more fonts.

23. The method of claim 22, wherein the popularity of the combinations of the user selected font and the set of one or more fonts is based on probabilities of co-occurrences of the combinations of the user selected font and the set of one or more fonts.
